(19) United States
(12) Patent Application Publication
(10) Pub. No.: US 2014/0353961 A1
(43) Pub. Date: Dec. 4, 2014

(54) FAST SNAP-ON CONNECTOR WITH LATCHES WITH SYMMETRICAL JAWS

(71) Applicants: Pierre MILHAS, Vitry-Le-Francois (FR); Yvon PAQUIS, Vitry-Le-Francois (FR); Gaël PIETTE, Dompremy (FR)

(72) Inventors: Pierre MILHAS, Vitry-Le-Francois (FR); Yvon PAQUIS, Vitry-Le-Francois (FR); Gaël PIETTE, Dompremy (FR)

(21) Appl. No.: 14/293,060

(22) Filed: Jun. 2, 2014

(30) Foreign Application Priority Data
Jun. 4, 2013 (FR) 1355143

(51) Int. Cl. F16L 21/08

(52) U.S. Cl. CPC F16L 21/08
USPC 285/82

(57) ABSTRACT

A female snap-on connector (1) intended to cooperate with a male attachment end fitting (20) of the type with a central bush (26) and a flange (25) includes a body (2) forming a cylindrical cavity and to which is fixed a cap (10) forming a housing for two symmetrical latch parts (50) disposed head-to-spigot, mounted to slide in the same transverse direction, each latch part (50) including a manoeuvring part (51), a rigid connecting rod (53) and a jaw (52) as well as spring means (55) for continuously urging each latch part (50) elastically into its rest position in which the jaw (52) is moved toward the axis and the manoeuvring part (51) is in its radially outermost position.

### TECHNICAL FIELD OF THE INVENTION

The present invention concerns a female snap-on connector intended to cooperate with a flanged male attachment end fitting.

### BACKGROUND OF THE INVENTION

In the present document, this combination of male and female members will be referred to as a “connector”. It is standard practice, notably in the automotive industry, to use such snap-on connectors for the fast and demountable connection of a fluid (for example fuel, oil or water) circuit element to another circuit element. The industry has substantially standardized on male end fittings including a cylindrical barrel surrounded by a flange and the female connectors include a cylindrical cavity intended to receive at least the end of the bush and an elastic latch intended to lock the rear of the flange once the latter is in place. O-rings provide the seal around the male end fitting.

The document EP 0 605 801 A discloses a connector in which the latch is symmetrical and disposed transversely in a latch housing formed between the opening of the cylindrical cavity of the body and a rigid entry ring of the body located at a distance in front of the opening of the cylindrical cavity of the body and fastened to the body. The latch part is an elastically deformable oval or lozenge and includes at two opposite vertices two manoeuvring parts and at two other vertices two jaws. In the rest position, the manoeuvring parts are flush with the exterior envelope of the body so as to be accessible to two opposed fingers of a user. When the user presses these parts radially inward, the latch part is deformed and moves the two jaws laterally away from each other and away from the axis of the body so that the jaws are retracted and release the central region adjoining the periphery of the male end fitting and allow disengagement of the flange and therefore of the male end fitting.

The lozenge-shaped single latch part proves in use in to be relatively fragile. To allow its elastic functioning, it is necessary to provide connecting parts that are neither too thick nor too rigid but because of this the jaws may be insufficiently retained and not exert on the flange of an end fitting a sufficient force to prevent the end fitting from being pulled out.

### SUMMARY OF THE INVENTION

The object of the invention is to improve a connector of this type through a construction enabling greater robustness and an increased resistance of the jaws to pulling out.

The invention achieves its object thanks to a female snap-on connector intended to cooperate with a male attachment end fitting of the type with a central bush and a flange, the connector including on the one hand a body made from a rigid plastic material and including on one side a tubular portion for connection to a pipe and on the other side a portion forming an open cylindrical cavity intended to receive at least the end of the bush, and a rigid entry ring of the body located a short distance in front of the opening of the cylindrical cavity of the body, while a latch, made from a rigid material and intended to lock behind the flange of the end fitting once the latter is in place in the cylindrical cavity (behind relative to the direction of insertion of the end fitting, but in front referred to the general orientation of the connector), is disposed transversely in a latch housing between the opening of the cylindrical cavity of the body and said rigid entry ring, the latch being symmetrical and including two radially opposed curved jaws adapted to be moved toward or away from each other and the axis of the body by the action of two radially opposite manoeuvring parts that in the rest position are flush with the exterior envelope of the body so as to be accessible to two opposed fingers of a user, the jaws being urged elastically into a close together rest position in which they form a radial abutment behind the flange of the end fitting when the latter is in place, the jaws enabling radial outward retraction of this radial abutment when they are pushed into the moved apart position by the manoeuvring parts when the latter are depressed by the user, characterized in that the latch consists of two symmetrical latch parts disposed head-to-spigot and sliding in opposite senses in the same transverse direction, each latch part being disposed in said transverse direction and including a manoeuvring part orthogonal to said transverse direction rigidly connected by a rigid connection rod to a jaw also substantially globally orthogonal to said transverse direction, sliding means and abutment means being formed in the latch housing to allow head-to-spigot sliding of each latch part over a limited travel between the rest and retracted positions of the jaws, spring means being provided between each latch part and a surrounding bearing member to urge each latch part continuously and elastically into its rest position in which the jaw is moved toward the axis and the manoeuvring part is in its radially outermost position.

Thanks to this arrangement, each lock part is a part that can be made very robust and the jaws can be very strong.

The surrounding bearing member referred to above on which bear the spring means that elastically push on each latch part may be an element fixed to the body of the connector. However, in accordance with a preferred feature of the invention, the surrounding member is in fact part of the antagonistic mobile latch part; in this way, when the user presses on the two manoeuvring parts, they reduce the distance between the bearing points of the spring and increase the elastic reaction force twice as quickly.

More particularly, the spring means of a latch part bear on the one hand on an exterior part of the curved jaw of said latch part and on the other hand on an interior part of the manoeuvring part of the other latch part disposed head-to-spigot.

The spring mans may be of any type, for example a coil spring placed between the two bearing points. The spring means are more advantageously constituted by a curved leaf spring disposed tangentially on one side of the jaw and progressively diverging therefrom.

The spring means may be parts separate from the latch part, which simply bear on it or are fixed to it. However, if the jaw is of moulded plastic, the spring is advantageously a curved leaf spring moulded in one piece with the jaw. In fact, the entire latch part may advantageously be moulded. In this case it is advantageous to employ a two-material moulding technique (for example overmoulding or two-material injection moulding) to produce the spring part in a suitable material, more elastic than the material from which the base part of the jaw is moulded.

The latch housing formed between the opening of the cylindrical cavity of body and the rigid entry ring is advantageously provided by a cap including a cover wall forming said rigid entry ring. This cap is fixed to the front of the body and its cover (or back); it includes a central passage and forms the rigid ring referred to above, which serves as a wall of the latch housing.

The cap may be fastened to the body by various means, for example by welding, but it is advantageously snap-fastened by means of hooks and attachment members formed on the body and/or the cap or conversely on the cap and the body. The attachment members cooperating with the hooks may be orifices, notches, raised patterns, formed in a wall of the cap. The hooks and the attachment members are advantageously such that demounting the cap is not possible.

Means for polarizing the cap on the body are advantageously provided, for example by making the cap a different colour to the body.

The cylindrical cavity of the body advantageously includes a cylindrical first section extending from the opening of the cylindrical cavity to a toroidal rib intended to receive the end of the male end fitting, the cylindrical first section having a diameter greater than that of the male end fitting and accommodating at least an O-ring, a spacer ring and a locking ring.

Two O-rings are preferably provided, separated by the spacer ring, which is mounted in the cylindrical first section. For its part the locking ring is force-fitted into the cylindrical first section to lock the O-rings and the spacer ring in place. It may have raised patterns, for example splines, on its periphery to facilitate force-fitting it.

The cylindrical cavity may include steps forming abutments for some of the aforementioned members, for example the locking ring.

### BRIEF DESCRIPTION OF THE DRAWINGS

Other features and advantages of the invention will emerge from the following description of one embodiment. Reference will be made to the appended drawings, in which:

FIG. 1 is a perspective view of the connector of the invention in the assembled state.

FIG. 2 is an exploded perspective view of the connector from FIG. 1 in the disassembled state.

FIG. 3 is a view in longitudinal section of the connector from FIG. 1 in the assembled state with the male end fitting mounted in the connector.

FIG. 4 is a perspective view of the cap of the connector of the invention shown separately.

FIGS. 5 and 6 represent in section taken along the line A-A in FIG. 3 the detail of the mechanism of the two symmetrical jaws of the invention, respectively in the closed rest position and in the open disengagement position.

FIG. 7 is a diagram representing a latch part and the guide members for the latch part in section and in elevation as seen from the left-hand side of the cap.

### DESCRIPTION OF PREFERRED EMBODIMENTS

The fast connector 1 essentially includes a body 2 that includes at the rear a tubular portion in the form of a hollow spigot 3 and at the front a cylindrical cavity or chamber 4 in which must be engaged a male end fitting 20 formed of a bush 26 provided with a clip-on flange 25. The spigot 3 may have on its exterior surface connection profiles, not shown, for example pine tree profiles or single or double bulges, for forcible engagement in a pipe, or may be welded (by rotation, ultrasound, induction or laser welding) to a tube or some other member. A cap 10 is clipped onto the front of the body 2 to form a transverse latch housing to be described in detail later.

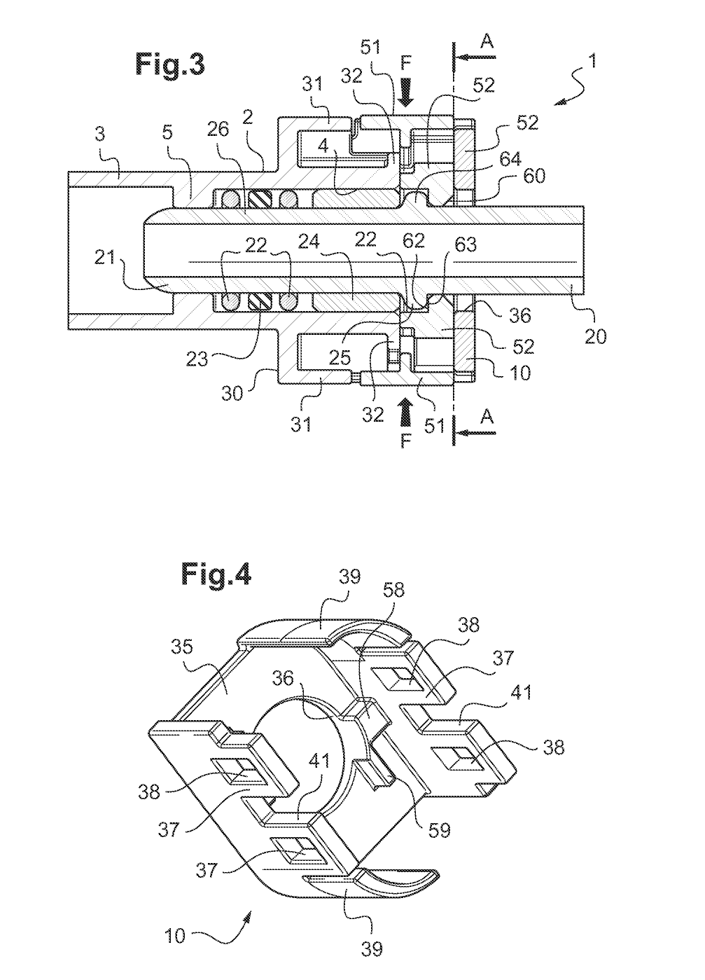

As FIG. 3 shows, the cylindrical chamber 4 is separated from the interior cylindrical volume of the spigot 3 by a toroidal rib 5 defining a cylindrical passage having an inside diameter adapted to have the distal end 21 of the male end fitting 20 pass through it. The cylindrical chamber 4 is able to receive two O-rings 22 separated by an O-ring spacer ring 23 and a locking ring 24 notched axially at its periphery so as to be engaged forcibly in the chamber 4 and fixed therein flush with the opening of the chamber 4. To facilitate reading of the drawing, the components 22-23-22-24 are shown separately, but it is to be understood that once assembled they bear one on another. The male end fitting 20 passes through the toroidal members 22-24 as its flange 25 bears in the vicinity of the locking ring 24 or even bear on it. A shoulder, not shown, may be formed in the cylindrical cavity for fixing an abutment for locating the locking ring 24.

The body 2 includes externally and toward its front portion an enlargement in the form of a square platform 30 with upstanding opposite low walls 31. A pillar 40 rises toward the front of the body 2 from the two opposite sides of the platform 30 that do not bear the low walls 31. The chamber 4 also forms at its front mouth a square transverse plate 32, parallel to the platform 30 but slightly smaller than it. Two snap-fastener hooks 33 are formed on each side on pillars 34 connecting the platform 30 and the plate 32.

The cap 10 includes a transverse front cover wall 35 with a central passage 36 through which the male end fitting 20 is able to pass without contact. This wall 35 forms the rigid entry ring of the body referred to at the start of this document. Two opposite lateral walls 37 include openings 38 intended to cooperate with the snap-fastener hooks 33 when the cap is positioned on the front end of the body 2. The openings 38 are separated by a notch 41 intended to cooperate with the pillars 40 for longitudinal guidance. The opposite plane lateral walls 37 are continued on one side by a quarter-circle wall 39.

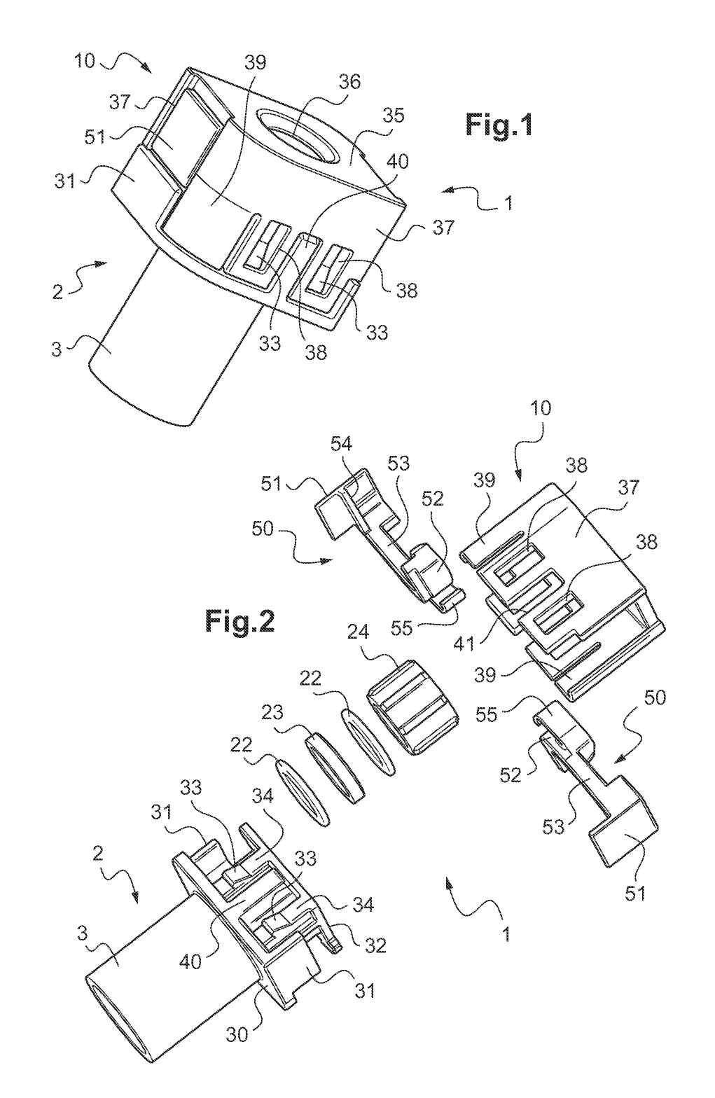

When the cap 10 is engaged on the front end of the body 2 and clips to it, its cover 35 is immobilized at a certain distance from the plate 32, forming between these two members a space intended to accommodate the latch. As seen in FIG. 1, the low lateral walls 31 partially close the lateral space between the end of the curved wall 39 and the edge of the opposite wall 37, which leaves two opposite rectangular lateral openings that expose the square manoeuvring button 51 of the locking latch, which in the rest position is flush with the surface of the envelope of the connector (consisting of the body and the cap). In a variant embodiment, the walls 31 may be on the cap 10 instead of on the body 2, which makes the cap more rigid and increases its resistance to pulling out.

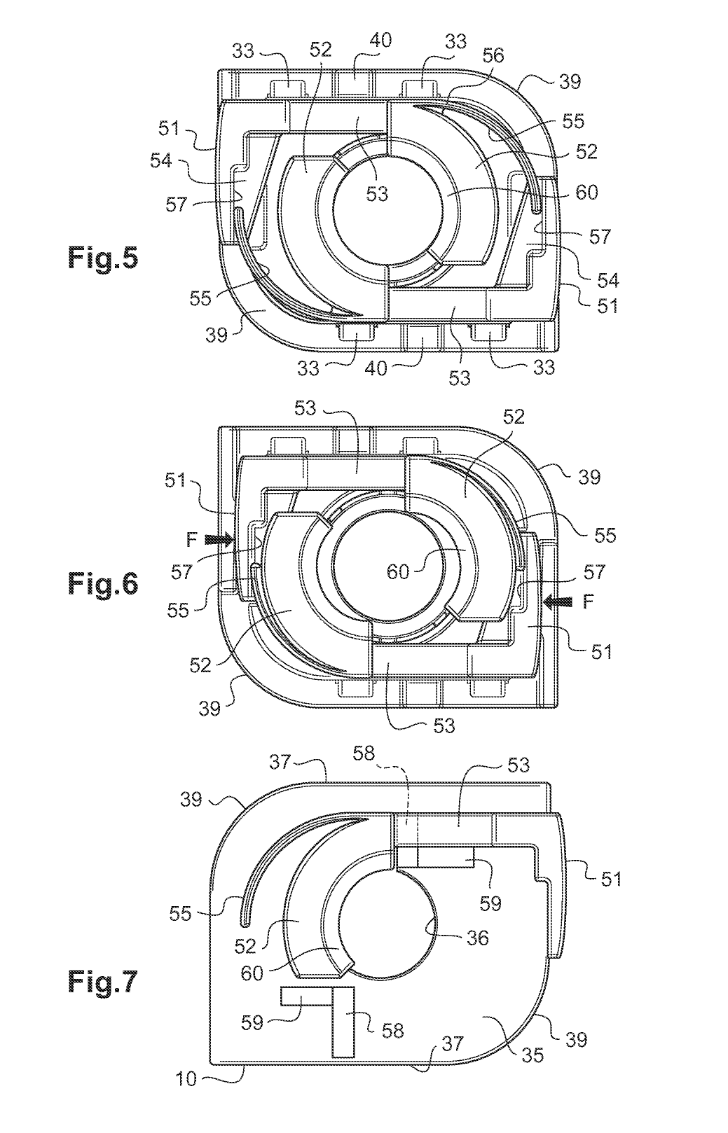

The latch consists of two identical latch parts 50 cooperating with each other and mounted in their housing, the two parts being mobile in a transverse direction that corresponds to the horizontal direction of the plane of FIGS. 5 and 6 and to the vertical direction of the plane of FIG. 3. They include a curved jaw portion 52 formed by a strong part subtending a circular arc of slightly more than 90° disposed in a transverse plane of the device and globally orthogonal to the direction of transverse sliding of the latch parts. The jaw 52 is connected by a rod 53 to the manoeuvring button 51 which is cantilevered at the end of the rod 53; reinforcing ribs 54 make the structure robust.

Moreover, a curved leaf spring 55 is moulded in one piece with the rest of the latch part 50. The base 56 of this leaf spring 55 is tangential to the jaw 52 at its end near the rod 53, and the leaf spring follows at an increasing distance the perimeter of the jaw 52. The end of the leaf spring 55, after a change of direction of approximately 90°, comes to bear on an internal face 57 of the manoeuvring button 51 of the other latch part 50 (the antagonistic part) disposed head-to-spigot relative to the first. The leaf spring 55 is prestressed so that its tends to be urged elastically away from the jaw 52 with which it is associated.

In FIG. 5, the two latch parts 50 are in the rest position, symmetrically separated from each other by the maximum distance. In this position of maximum distance between the parts 50 at the level of their manoeuvring buttons 51 the external face of which is flush with the lateral surface of the cap 10, the jaws 52 are to the contrary in their concentrically closest together position. This rest position is defined by the cooperation of a raised pattern of the parts 50 and two abutments 58 (FIGS. 4 and 7) formed in the cap 10, inside its cover wall 35, in the vicinity of the central passage 36. In this close-together position, the jaws 52 define between them an interrupted ring having an inside diameter between the outside diameter of the male end fitting 20 and that of the flange 25, so that in the position represented in FIGS. 3 and 5 the flange 25 is prevented from disengagement toward the front of the connector (toward the rear of the end fitting relative to its insertion direction). It is therefore immobilized axially on both sides, which fixes the end fitting 20 in the connector.

The guide means for the latch parts 50 are shown diagrammatically in FIG. 7 (only one of the two latch parts 50 is shown to simplify the figure): there are seen in the vicinity of the central opening 36 of the cover 35 of the cap 10 the two transverse abutments 58 (orthogonal to the walls 37) and two slides 59 (parallel to the walls 37) that cooperate with the rod 53 of the latch part 50. The rod 53 slides between the wall 37 and the slide 59. A recess, not shown, under the rod 53 cooperates with the abutment 58 to define the transverse travel of the latch part 50. Of course, the travel abutments may be produced by other means.

If the user simultaneously presses the two pushbuttons 51 of the latches 50, in the direction of the arrows F in FIG. 3 or 6, each of the parts 50 will slide transversely, guided by the slides 59 on cap (FIG. 4). The two parts 50 will move globally toward each other until at the end of travel their ad hoc raised pattern abuts on the abutment 58 but, in doing so, the two jaws 52 will move away from each other, into the position represented in FIG. 6, which then, thanks to this retraction, allows the flange 25 to pass in front of the body between the two jaws 52. During this movement, the springs 55 move elastically toward the curved perimeter of the jaws 52, continuing to bear on the bearing surfaces 57 inside the opposite pushbuttons 51.

It suffices for the user to release the manual pressure on the two pushbuttons 51 for the elastic force of the springs 55 to return the two latch parts 50 to their globally separated position in FIG. 5, which is the rest position locking the end fitting.

As seen in the FIG. 3 section of the jaws 52, each arcuate jaw 52 includes a leading portion of small inside diameter forming a conical chamfer 60 followed by a cylindrical enlargement 61 the front face 62 of which forms a transverse abutment shoulder for the flange 25 that also includes toward the front of the connector a substantially transverse abutment face 63 while its rear face 64 is inclined and intended to slide on the leading chamfer 60 of the jaws, which enables the jaws to open automatically on insertion of the end fitting 20, the end fitting 20 then being retained by virtue of the cooperation of the two transverse faces 63, 62 abutted against each other.

The body 2, the cap 10 and the latch parts 50 are advantageously made of moulded plastic, and the plastic may be different for the various parts.

What is claimed is:

1. Female snap-on connector intended to cooperate with a male attachment end fitting of the type with a central bush and a flange, the connector including on the one hand a body made from a rigid plastic material and including on one side a tubular portion for connection to a pipe and on the other side a portion forming an open cylindrical cavity intended to receive at least the end of the bush, and a rigid entry ring of the body located a short distance in front of the opening of the cylindrical cavity of the body, while a latch, made from a rigid material and intended to lock behind the flange of the end fitting once the latter is in place in the cylindrical cavity, is disposed transversely in a latch housing between the opening of the cylindrical cavity of the body and said rigid entry ring, the latch being symmetrical and including two radially opposed curved jaws adapted to be moved toward or away from each other and the axis of the body by the action of two radially opposite manoeuvring parts that in the rest position are flush with the exterior envelope of the body so as to be accessible to two opposed fingers of a user, the jaws being urged elastically into a close together rest position in which they form a radial abutment behind the flange of the end fitting when the latter is in place, the jaws enabling radial outward retraction of this radial abutment when they are pushed into the moved apart position by the manoeuvring parts, wherein the latch consists of two symmetrical latch parts disposed head-to-spigot and sliding in opposite senses in the same transverse direction, each latch part being disposed in said transverse direction and including a manoeuvring part orthogonal to said transverse direction rigidly connected by a rigid connection rod to a jaw also substantially globally orthogonal to said transverse direction, sliding means and abutment means being formed in the latch housing to allow head-to-spigot sliding of each latch part over a limited travel between the rest and retracted positions of the jaws, spring means being provided between each latch part and a surrounding bearing member to urge each latch part continuously and elastically into its rest position in which the jaw is moved toward the axis and the manoeuvring part is in its radially outermost position.

2. Connector according to claim 1, wherein the surrounding bearing member is a portion of the antagonist latch part.

3. Connector according to claim 1, wherein the spring means of one latch part bear on the one hand on an exterior portion of the curved jaw of said latch part and on the other hand on an interior portion of the manoeuvring portion of the antagonistic other latch part disposed head-to-spigot with it.

4. Connector according to claim 1, wherein the spring means consist of a curved leaf spring disposed tangentially one side of the jaw and progressively diverging from it.

5. Connector according to claim 1, wherein the jaw is of moulded plastic and the spring means are a curved leaf spring moulded in one piece with the jaw.

6. Connector according to claim 5, wherein the jaw and the curved leaf spring are produced by moulding two materials.

7. Connector according to claim 1, wherein the latch housing is produced by a cap including a cover wall forming said rigid entry ring.

8. Connector according to claim 7, wherein the cap is snap-fastened to the body by hooks and attachment members formed on the body and on the cap or conversely on the cap and the body.

9. Connector according to claim 1, wherein the cylindrical cavity of the body includes a cylindrical first section extending from the opening of the cylindrical cavity to a toroidal rib intended to receive the end of the male end fitting, the cylindrical first section having a diameter greater than that of the male end fitting and accommodating at least one O-ring, a spacer ring and a locking ring.

10. Connector according to claim 9, wherein the locking ring is force-fitted in the cylindrical first section to lock the O-ring and the spacer ring.
